(19) United States
(12) Patent Application Publication
(10) Pub. No.: US 2026/0302687 A1
(43) Pub. Date: Oct. 1, 2026

(54) USB-C Connector

(71) Applicant: Microsoft Technology Licensing, LLC, Redmond, WA (US)

(72) Inventors: Cameron Delaney LOCHER, Seattle, WA (US); Jazmine HOYLE, Bellevue, WA (US); Thomas Joseph LONGO, Hopewell Junction, NY (US)

(73) Assignee: Microsoft Technology Licensing, LLC, Redmond, WA (US)

(21) Appl. No.: 19/090,928

(22) Filed: Mar. 26, 2025

(51) Int. Cl. H01R 13/62; H01R 13/502

(52) U.S. Cl. CPC H01R 13/6205; H01R 13/502

(57) ABSTRACT

This document generally relates to USB-C connections between devices and cords or cables. One example device includes a housing including multiple surfaces that collectively define a volume. The device also includes a USB-C receptacle positioned within the volume and recessed behind an individual surface. The recessed USB-C receptacle includes a USB-C compliant arrangement of pins. The example also includes a funnel that extends through the individual surface to the recessed USB-C receptacle.

### BACKGROUND

Several generations of universal serial bus (USB) connectors and protocols, including USB-C, have facilitated data and power transmission between various devices. The connectors involve a plug on a cord or cable that is mechanically received in a port on a device to electrically connect pins in the port and the plug.

### SUMMARY

This document generally relates to USB-C connections between devices and cords/cables. One example device includes a housing including multiple surfaces that collectively define a volume. The device also includes a USB-C receptacle positioned within the volume and recessed behind an individual surface. The recessed USB-C receptacle includes a USB-C compliant arrangement of pins. The example also includes a funnel that extends through the individual surface to the recessed USB-C receptacle.

Another example relates to a USB-C cable that includes insulated conductors extending between first and second plugs. The first plug includes an obround cylindrical shaped terminal around a USB-C compliant arrangement of pins that are connected to the insulated conductors. The second plug comprising a terminal including a proximal relatively larger obround cylindrical shaped portion and a distal relatively smaller obround cylindrical shaped portion that are connected by a tapered intermediate portion. The distal relatively smaller obround cylindrical shaped portion includes another USB-C compliant arrangement of pins that are connected to the insulated conductors. As used herein, ‘obround’ means a two-dimensional (2D) racetrack shape with circular ends connected by straight lines. Similarly, ‘obround cylindrical shape’ is a 3D shape where the obround 2D shape is drawn out into 3D (e.g., a water trough shape).

Still another example includes a USB-C cable that includes insulated conductors extending between a first USB-C plug and a second magnetic USB-C plug. The first USB-C plug includes a first housing, and a first terminal positioned around a first USB-C compliant arrangement of pins that are connected to the insulated conductors. The second magnetic USB-C plug includes a second housing including magnets and a second terminal extending from the housing a shorter length than the first terminal and positioned around another USB-C compliant arrangement of pins that are connected to the insulated conductors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1A-1F illustrate example magnetic USB-C use case scenarios in which some of the present concepts can be employed in accordance with some implementations.

FIGS. 2A and 3A illustrate perspective views of example magnetic USB-C components that can implement some of the present concepts in accordance with some implementations.

FIGS. 2B and 3B illustrate exploded perspective views of example magnetic USB-C components that can implement some of the present concepts in accordance with some implementations.

FIGS. 2C, 3C, and 3D illustrate elevational views of example magnetic USB-C components that can implement some of the present concepts in accordance with some implementations.

FIGS. 4A-4D and 5A-5I illustrate sectional views of example USB-C components that can implement some of the present concepts in accordance with some implementations.

### DETAILED DESCRIPTION

### Overview

This patent relates to universal serial bus type-C (USB-C) connectors. More specifically, the present concepts provide USB-C connectors that enhance user experiences with their devices. Currently, the technology industry is struggling between giving users a charging port that is universal and works across different chargers/cables, and a custom magnetic port that provides users with a delightful magnetic experience allowing for quick, accessible attachment and detachment.

Some proprietary systems have prioritized a magnetic experience for users. These systems provide the aforementioned magnetic benefits, such as convenient attachment and detachment as well as breakaway in tripping scenarios. The issue with proprietary magnetic solutions is that the user has to have a dedicated charger for their device. Further, if they are not actively charging their device, the magnetic receptacle serves no other function and provides no value, leaving wasted space on their device. In turn, the dedicated charger is not useful for charging other devices.

Consumers increasingly desire more universal charging among devices, such as USB-C offers. However, USB-C utilizes mechanical retention of the cord at the port. Thus, tripping scenarios can damage the USB-C port and/or cause the device to fall and be damaged. This creates tension for all device manufacturers to balance the cost and internal space it takes to provide users with both proprietary magnetic and USB-C options, or to forego the magnetic benefits by putting in only a standard USB-C port.

The present concepts provide a technical solution that solves both of these technical problems (e.g., universality and magnetic attachment). This technical solution provides magnetic attachment and detachment on a USB-C port. This technical solution can be accomplished by offloading several novel aspects of the magnetic experience to the USB-C cable that can include a tapered magnetic USB-C plug. The device can include a USB-C magnetic funnel port.

The device's USB-C magnetic funnel port functions as a standard USB-C port for receiving a standard USB-C plug. The USB-C magnetic funnel port also magnetically attracts and receives the tapered magnetic USB-C plug to provide delightful quick attachment and detachment as well as emergency breakaway in tripping scenarios. On the device side, the USB-C magnetic funnel port provides the user with a fully compliant standard USB-C port that can be used for charging, data, docking, accessories, thumb drives, and more. However, the design of the USB-C magnetic funnel port includes novel concepts that allow seamless attachment where the user does not need to bother with precise alignment, and ease of detachment by simply pulling on the USB-C cable. This technical solution can be implemented entirely into the device and does not rely on any additional parts or dongles between the USB-C port and the USB-C plug. Further, this technical solution provides the convenience of magnetic USB-C attachment and can also support standard USB-C mechanical attachment as desired.

### Example Use Case Scenarios

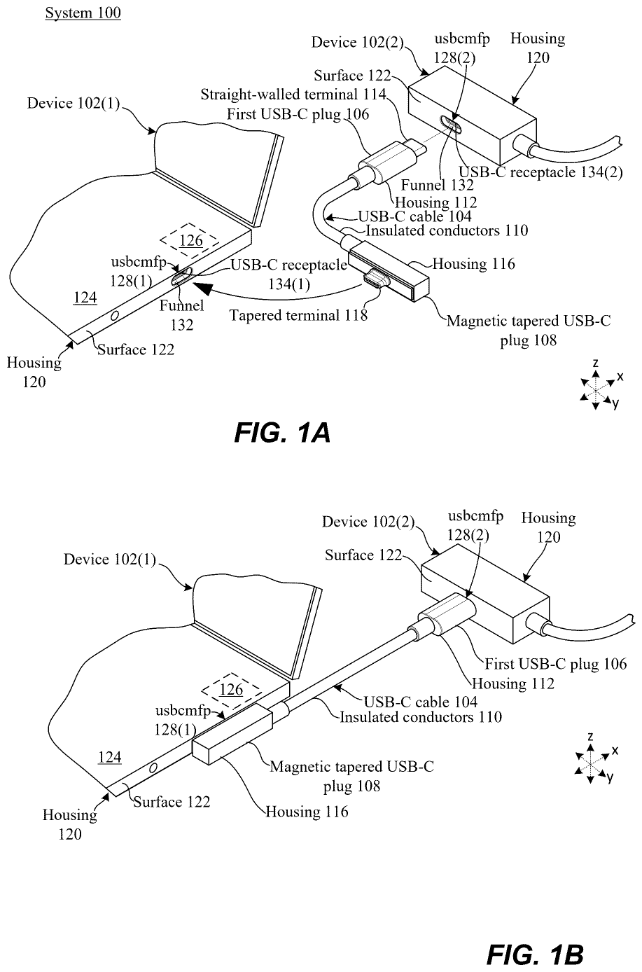

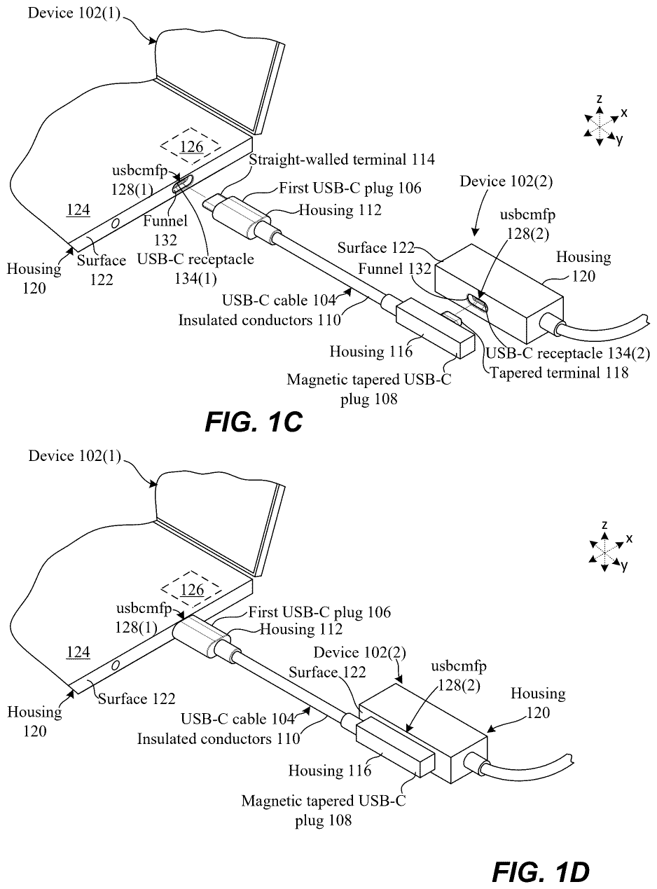

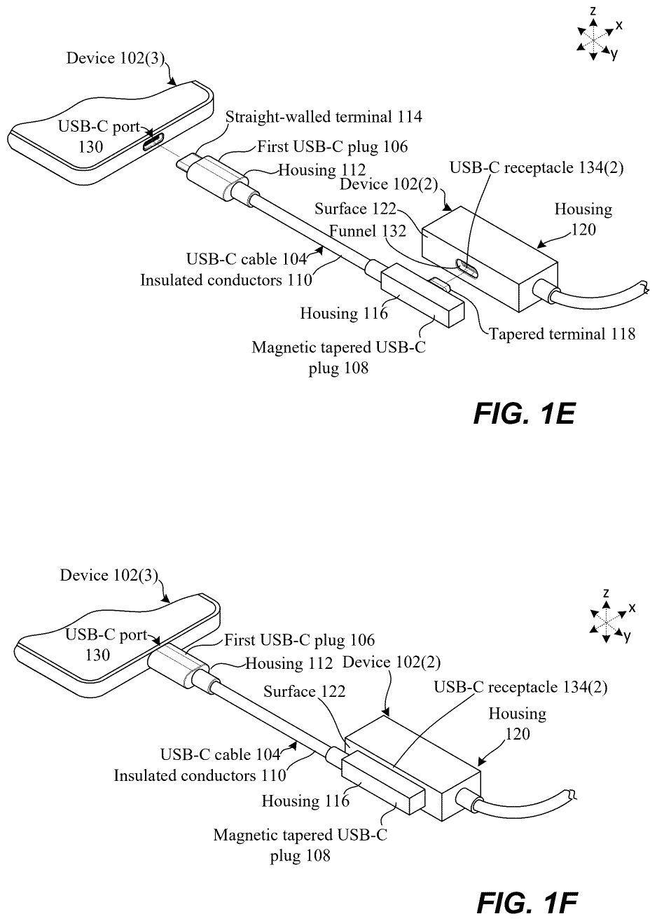

FIGS. 1A-1F collectively show magnetic USB-C coupling use case scenarios involving some of the present concepts implemented on an example system 100. This system 100 includes devices 102 that can be coupled via a USB-C cord or cable 104. The USB-C cable 104 includes a first USB-C plug 106 and a second USB-C plug embodied as a tapered magnetic USB-C plug 108. A length of insulated wires or other conductors 110 connects the first USB-C plug 106 and the second tapered magnetic USB-C plug 108. The first USB-C plug 106 includes a housing 112 and a generally straight-walled terminal 114. The second tapered magnetic USB-C plug 108 includes a housing 116 and a tapered terminal 118.

In this case, device 102(1) is manifest as a notebook computer, device 102(2) is manifest as a power supply unit (PSU), and device 102(3) (introduced on FIG. 1E) is manifest as a smart phone. Other device form factors are contemplated, such as tablets, TVs, internet of things (IoT) devices, etc. The devices 102 include a housing 120 that entails surfaces 122 that collective define an internal volume 124. Various electronic components 126, such as processors and/or batteries, among others, can be positioned in the volume 124. For purposes of explanation, devices 102(1) and 102(2) include USB-C magnetic funnel ports 128 while device 102(3) includes a standard USB-C port 130.

The USB-C magnetic funnel ports 128 include a funnel 132 that extends from an individual surface 122 to a USB-C receptacle 134 positioned in the volume 124. The USB-C receptacle 134 can be electrically connected to the electronic components 126.

FIG. 1A shows the USB-C cable 104 detached from the devices 102. The first USB-C plug 106 is proximate to device 102(2) and the second tapered magnetic USB-C plug 108 is proximate to device 102(1). Coupling the first USB-C plug 106 with device 102(2) entails the user guiding the first USB-C plug 106 toward and into USB-C magnetic funnel port 128(2) perpendicular to surface 122. Precise alignment of the straight-walled terminal 114 with the USB-C magnetic funnel port 128(2) leads to successful insertion. In contrast, attractive magnet forces automatically bias the second tapered magnetic USB-C plug 108 towards USB-C magnetic funnel port 128(1) on device 102(1). This magnetic force both automatically pulls the second tapered magnetic USB-C plug 108 towards the USB-C magnetic funnel port 128(1) and automatically aligns the second tapered magnetic USB-C plug 108 with the USB-C magnetic funnel port 128(1). Further, the funnel 132 of device 102(1) and the shape of the tapered terminal 118 facilitate (e.g., guide) the tapered terminal 118 toward the USB-C magnetic funnel port 128(1) whether the tapered terminal is approaching perpendicular to surface 122 or at other approach angles.

FIG. 1B shows second tapered magnetic USB-C plug 108 coupled with USB-C magnetic funnel port 128(1) of device 102(1) and first USB-C plug 106 coupled with USB-C magnetic funnel port 128(2) of device 102(2). At this point, first USB-C plug 106 is retained in USB-C magnetic funnel port 128(2) by mechanical engagement of straight-walled terminal 114 with USB-C magnetic funnel port 128(2). In contrast, second tapered magnetic USB-C plug 108 is retained in USB-C magnetic funnel port 128(1) by the magnetic forces between the second tapered magnetic USB-C plug 108 and the USB-C magnetic funnel port 128(1). The magnetic forces position the tapered terminal 118 against USB-C receptacle 134(1) sufficient to make electrical connections rather than relying on mechanical engagement. Thus, at the stage shown at FIG. 1B, second tapered magnetic USB-C plug 108 is retained in USB-C magnetic funnel port 128(1) by the magnetic forces unless acted upon by an external force (e.g., the user pulling on the USB cable intentionally or unintentionally). Regardless of angle, the external force can overcome the magnetic force and disconnect second tapered magnetic USB-C plug 108 from USB-C magnetic funnel port 128(1) without damage to the second tapered magnetic USB-C plug 108, USB-C magnetic funnel port 128(1), and/or device 102(1). In contrast, only an external force on first USB-C plug 106 that is perpendicular to surface 122 of device 102(2) can detach the first USB-C plug 106 from the device 102(2) without damage to device 102(2) and/or the USB-C cable 104. This difference is further illustrated in FIGS. 1C and 1D.

For purposes of explanation, FIGS. 1C and 1D show the ends of USB-C cable 104 swapped relative to FIGS. 1A and 1B, respectively. In FIG. 1C, second tapered magnetic USB-C plug 108 is proximate to device 102(2) and first USB-C plug 106 is proximate to device 102(1). The user can achieve electrical connection by moving the first USB-C plug 106 into funnel 132 of device 102(1). The straight-walled terminal 114 will mechanically engage the USB-C receptacle 134(1) to mechanically retain the first USB-C plug 106 in the device and electrically connect the device 102(1) to the USB-C cable 104. The user can achieve electrical connection between the USB-C cable 104 and device 102(2) by moving the second tapered magnetic USB-C plug 108 proximate to the USB-C magnetic funnel port 128(2). Alignment and angle need not be precise because attractive magnetic forces will automatically guide the tapered terminal 118 into the funnel 132 and against the USB-C receptacle 134(2) sufficient to electrically connect the device 102(2) and the second tapered magnetic USB-C plug 108 as shown in FIG. 1D.

At this point, magnetic forces hold the tapered terminal 118 in the funnel 132. As such, sufficient external forces (intentional or accidental) can readily detach the second tapered magnetic USB-C plug 108 from the device 102(2), which provides both convenience and safety.

As evidenced from the explanation above relative to FIGS. 1A-1D, the USB-C magnetic funnel ports 128 of devices 102(1) and 102(2) can accommodate both the first USB-C plug 106 and the second tapered magnetic USB-C plug 108. In this example, the first USB-C plug 106 is a stand-in for a standard USB-C plug. When the tapered magnetic USB-C plug 108 is employed, the USB-C magnetic funnel ports 128 provide a delightful user experience where the user can simply bring the tapered magnetic USB-C plug 108 toward the USB-C magnetic funnel port 128 and the magnetic forces take over to automatically align and connect the USB-C cable to the device. The tapered magnetic USB-C plug 108 will not fall out, but the user can detach the tapered magnetic USB-C plug 108 by simply pulling on the USB-C cable 104. If a tapered magnetic USB-C plug 108 is not available, the USB-C magnetic funnel port 128 can accommodate the first USB-C plug 106 or equivalent. The user can physically push the straight-walled terminal 114 into the USB-C magnetic funnel port 128 and it will be mechanically retained by physical engagement of the straight-walled terminal 114 and the USB-C receptacle 134.

The description above of FIGS. 1A-1D can be applicable to a set of components designed to work together (e.g., a notebook computer, its power supply unit, and USB-C cable for connecting the two). Both of the devices 102(1) and 102(2) have USB-C magnetic funnel ports 128. The notebook computer is often connected and disconnected to the USB-C cable 104, while the power supply unit is less frequently disconnected from the USB-C cable. As such, the user can utilize the tapered magnetic USB-C plug 108 with the notebook computer to have seamless coupling and decoupling between the notebook computer and the USB-C cable.

However, in addition to this convenient attach and detach, as mentioned above, the present concepts offer universality for use with all USB-C compliant devices. For instance, while using their notebook computer, the user's smart phone battery may need charging and they may not have another charger with them. The present concepts allow the user to charge their smart phone with the components described above. This aspect is described below relative to FIGS. 1E and 1F.

FIGS. 1E and 1F explain how the USB-C cable 104 can be used with devices that do not have USB-C magnetic funnel ports 128 and instead have a standard USB-C port 130. The tapered magnetic USB-C plug 108 is not intended for use in standard USB-C ports 130. In this example, the tapered magnetic USB-C plug 108 is coupled with device 102(2) (e.g., the power supply unit). First USB-C plug 106 can be inserted into and mechanically connected to standard USB-C port 130 on device 102(3) to be charged by the power supply unit. In this configuration, the magnetic attachment is not available between USB-C cable 104 and device 102(3), however a user who may have otherwise had a dead smartphone now has a solution and an improved user experience.

Note also that device 102(1) (e.g., the notebook computer) can be swapped with device 102(2) (e.g., the PSU) to allow charging the smartphone with the notebook computer and/or to transfer data between the smartphone and the notebook computer. This scenario is applicable to other example devices besides those illustrated here. Further, note that the present concepts provide backwards compatibility. If the user forgets their PSU (e.g., device 102(2)) and USB-C cable 104, the user can connect a standard USB-C cable to their notebook computer (e.g., device 102(1)) via USB-C magnetic funnel port 128(1) of FIG. 1A for power and/or data transfer but will lack the magnetic attachment/detachment features.

### Example Configurations

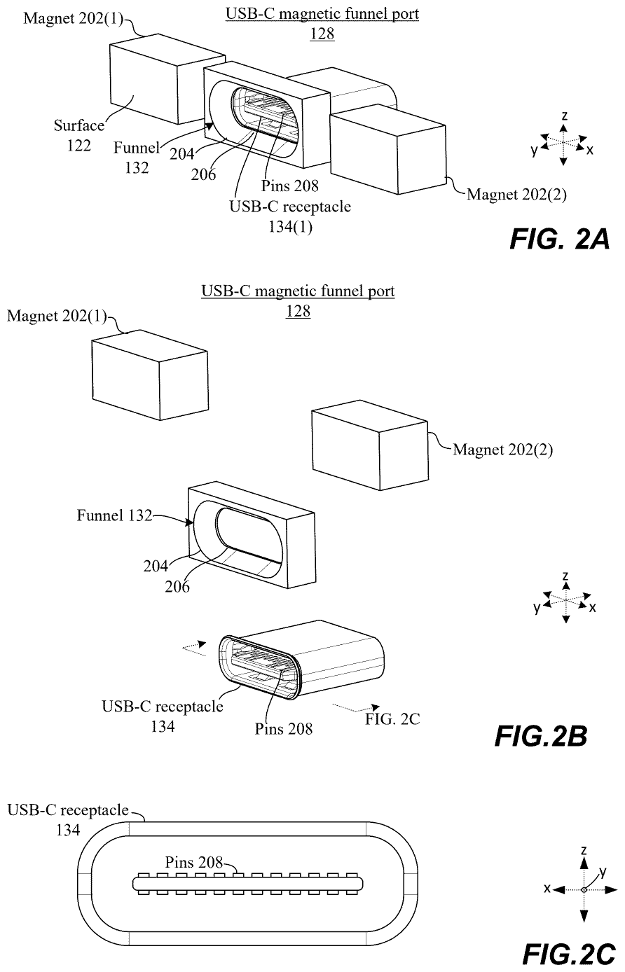

FIGS. 2A-2C collectively show details of an example USB-C magnetic funnel port 128. In this case, magnets 202 are positioned on each side of the funnel 132 along the x reference axis (e.g., the funnel 132 is interposed between a pair of magnets). The magnets 202 are positioned relative to the funnel 132 to contribute magnetic force that automatically aligns an approaching tapered magnetic USB-C plug 108 with the funnel. The magnets 202 can be directly adjacent (e.g., touching) the funnel 132 or spaced away from the funnel. Other magnetic configurations are contemplated. For instance, a ring of magnets could be placed around the funnel 132. The funnel 132 extends from the surface 122 in the y reference direction. For example, in some configurations the funnel 132 can extend one to two millimeters from the surface 122 into the volume as measured orthogonally to the surface. The USB-C receptacle 134 is positioned behind the funnel 132 (e.g., farther from the surface 122). The funnel 132 and the magnets 202 can collectively define a portion of the surface 122. Alternatively, the device housing (120, FIG. 1A) can define the surface 122 over the magnets 202 and funnel 132 with a cutout for the funnel opening. Funnel 132 has a relatively larger obround shape at the first surface 122 as indicated at 204 and a relatively smaller obround shape at the USB-C receptacle as indicated at 206.

The USB-C receptacle 134 includes a USB-C compliant arrangement of pins 208 (hereinafter, may be referred to as ‘pins’). The pins 208 are readily visible in the sectional view of FIG. 2C, which is taken in the xz reference plane. In this example, the pins 208 are arranged into two rows or arrays of twelve (12) pins each. The pins 208 electrically connect to USB-C plugs, both regular USB-C plugs, such as first USB-C plug 106 described relative to FIGS. 1A-1F, and tapered magnetic USB-C plug 108 described relative to FIGS. 1A-1F.

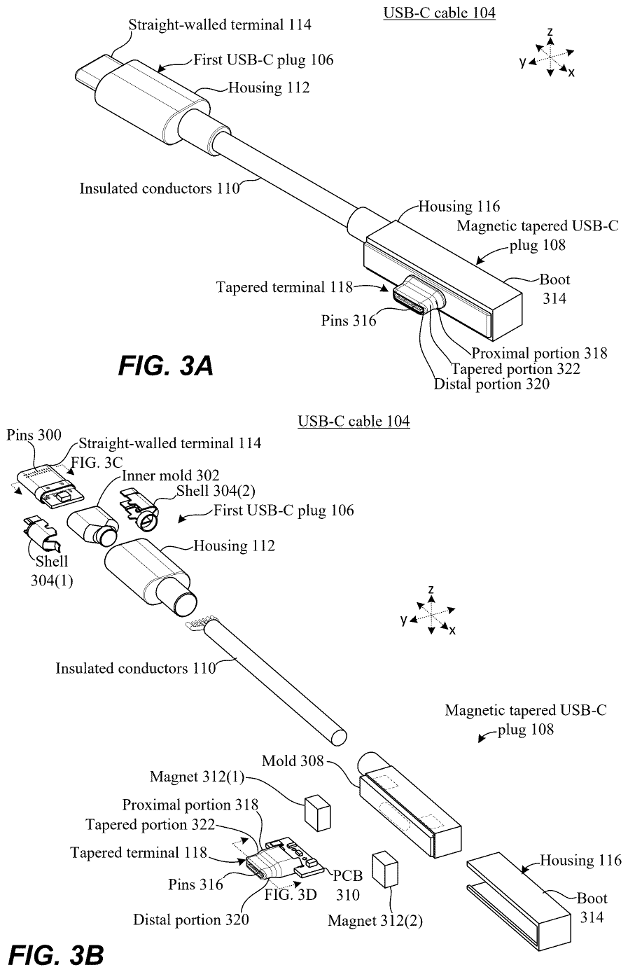

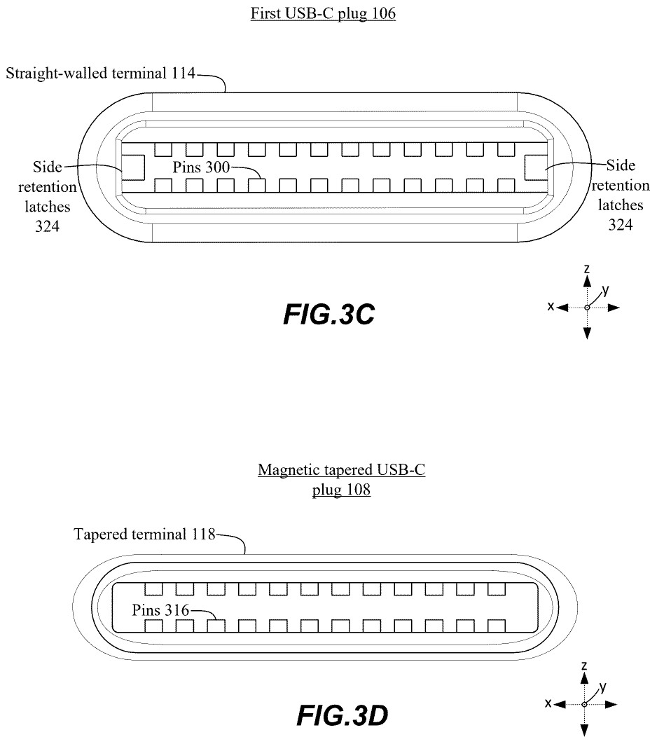

FIGS. 3A-3D collectively show details of an example USB-C cable 104. The first USB-C plug 106 includes straight-walled terminal 114 which includes an arrangement of USB-C compliant pins 300, inner mold 302, shells 304, and housing 112. (Note that the pins 300 would be obscured in the views of FIGS. 3A and 3B, but are shown in ghost on FIG. 3B for purposes of explanation. The pins 300 are readily visible on the sectional view of FIG. 3C). In this example, the pins 300 are arranged into two rows of 12 pins each that are configured to contact the corresponding pins 208 of the USB-C receptacle 134.

On first USB-C plug 106, exposed ends (shown but not designated) of the insulated conductors 110 pass through the housing 112, shell 304(2), and the inner mold 302. The exposed ends are attached to the straight-walled terminal 114. The exposed ends and proximal portion of the straight-walled terminal are then protected by the inner mold 302, shells 304, and housing 112.

Tapered magnetic USB-C plug 108 includes mold 308, printed circuit board 310, tapered terminal 118, magnets 312, and boot 314. The boot 314 forms part of the housing 116. The tapered terminal 118 includes a USB-C compliant arrangement of pins 316 (hereinafter, may be referred to as ‘pins’). The pins 316 are readily visible in the sectional view of FIG. 3D, which is taken in the xz reference plane. In this example, the pins 316 are arranged into two rows of 12 pins each that are configured to contact the corresponding pins 208 of the USB-C receptacle 134.

During assembly, exposed ends (not shown) of the insulated conductors 110 extend through mold 308 and are electrically connected to the printed circuit board 310. The printed circuit board 310 is associated with the tapered terminal 118. The printed circuit board 310 is physically secured by mold 308 and boot 314 so that the tapered terminal 118 extends from the boot. The magnets 312 are positioned in the mold 308 on each side of tapered terminal 118. Other magnet configurations are contemplated, such as a ring of magnets around the tapered terminal 118.

In this configuration, the tapered terminal 118 includes a proximal relatively larger obround cylindrical shaped portion 318 (labeled on FIG. 3B as ‘proximal portion 318’), a distal relatively smaller obround cylindrical shaped portion 320 (labeled on FIG. 3B as ‘distal portion 320’), and a tapered intermediate portion 322 (labeled on FIG. 3B as ‘tapered portion 322’). The shape of the tapered terminal provides a technical solution that both promotes entrance of the tapered terminal into the funnel and limits the extent (depth) of travel into the funnel. The pins 316 extend from the tapered intermediate portion 322 toward the distal relatively smaller obround cylindrical shaped portion 320.

Note that in the illustrated configuration, the insulated conductors 110 generally extend parallel to the x reference axis. The first USB-C plug 106 includes housing 112 that extends along a long axis that is also parallel to the x reference axis. The first USB-C plug 106 receives the insulated conductors 110 coextensive with the long axis of the housing 112 and the straight-walled terminal 114 extends generally coextensive with the long axis.

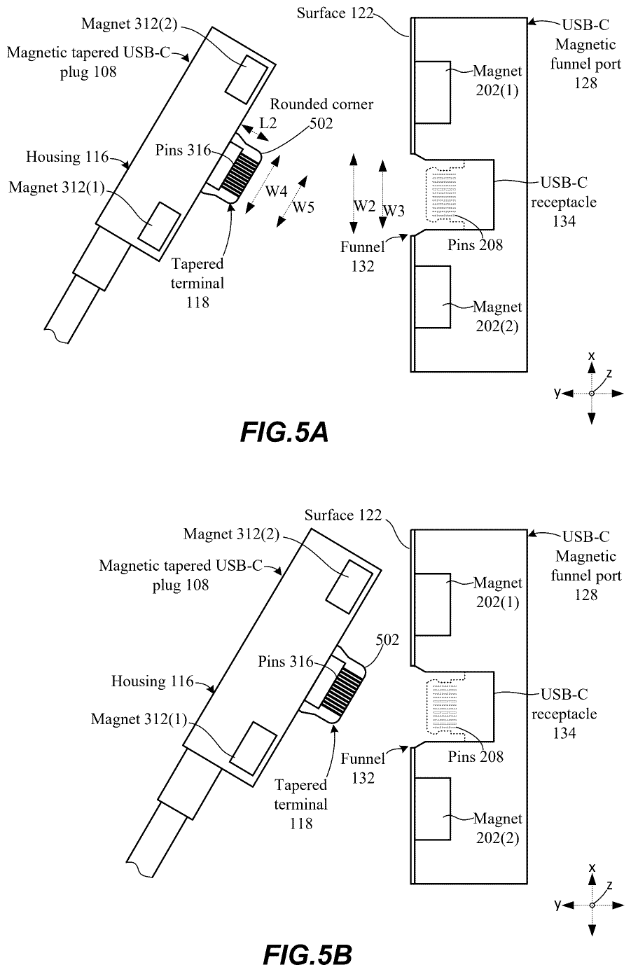

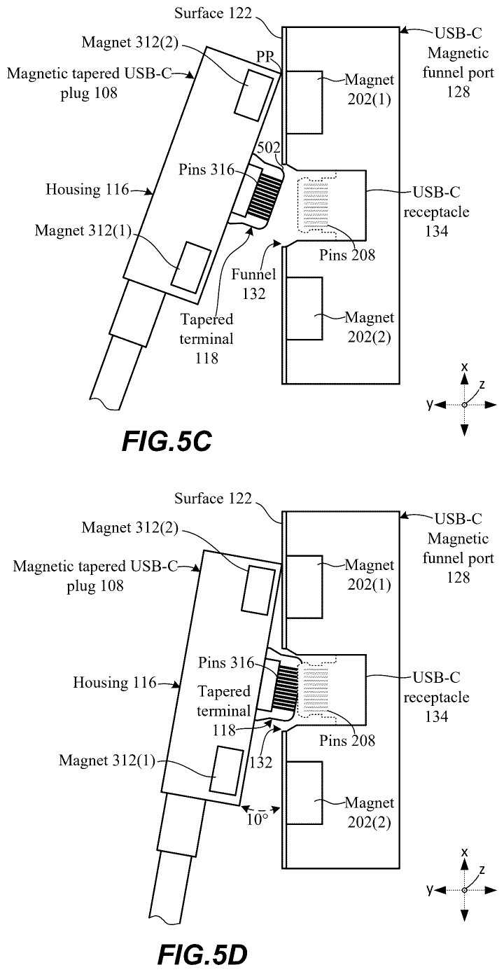

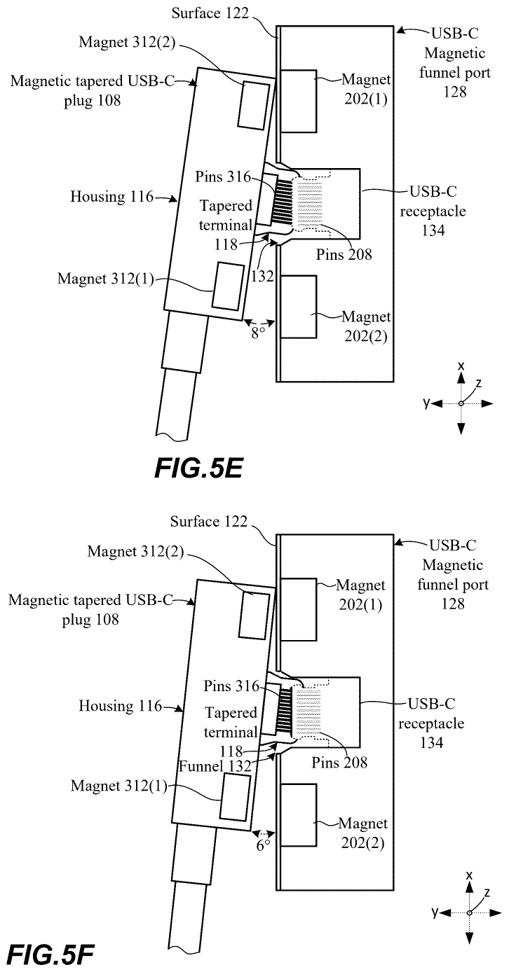

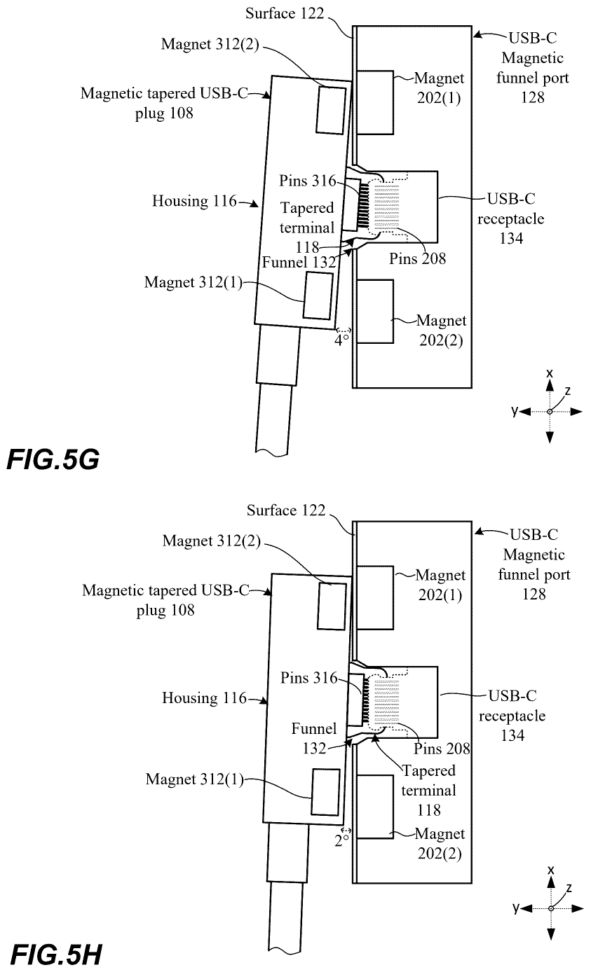

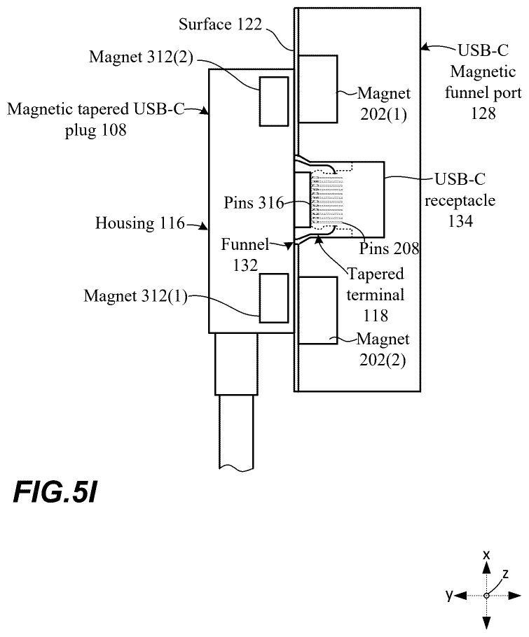

The tapered magnetic USB-C plug 108 includes housing 116 that also extends along a long axis that is parallel to the x reference axis. The tapered magnetic USB-C plug 108 receives the insulated conductors 110 generally coextensive with the long axis of the housing 116. However, the tapered terminal 118 extends generally orthogonally to the long axis (e.g., parallel to the y reference direction). This configuration of the tapered magnetic USB-C plug 108 facilitates easy magnetic coupling of the tapered magnetic USB-C plug 108 with the USB-C magnetic funnel port 128 as will be described below relative to FIGS. 5A-5I. This configuration also reduces any likelihood of the user accidentally bumping the tapered magnetic USB-C plug 108 which remains tucked along the surface of the device when attached.

FIG. 3C shows a sectional view of straight-walled terminal 114 of first USB-C plug 106. The pins 300 are arranged in two parallel and spaced-apart rows. The rows are bounded by side retention latches 324. The side retention latches 324 physically engage USB-C ports to mechanically retain the straight-walled terminal 114 in the USB-C ports and to facilitate electrical connection of the pins 300 to pins in the USB-C ports (e.g., the pins 208 of FIG. 2C).

FIG. 3D shows a sectional view of tapered magnetic USB-C plug 108 through the tapered terminal 118. Pins 316 are similar or identical to pins 300 of FIG. 3C. However, note that tapered magnetic USB-C plug 108 does not require mechanical retention in USB-C ports due to the magnetic retention features described above and below. Thus, tapered magnetic USB-C plug 108 does not need the side retention latches employed in the first USB-C plug 106.

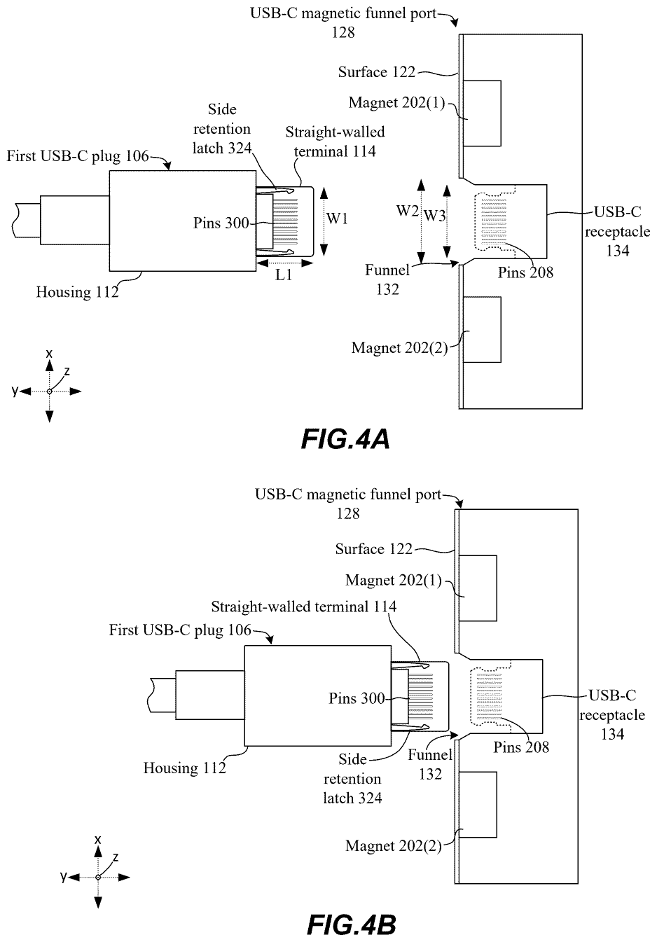

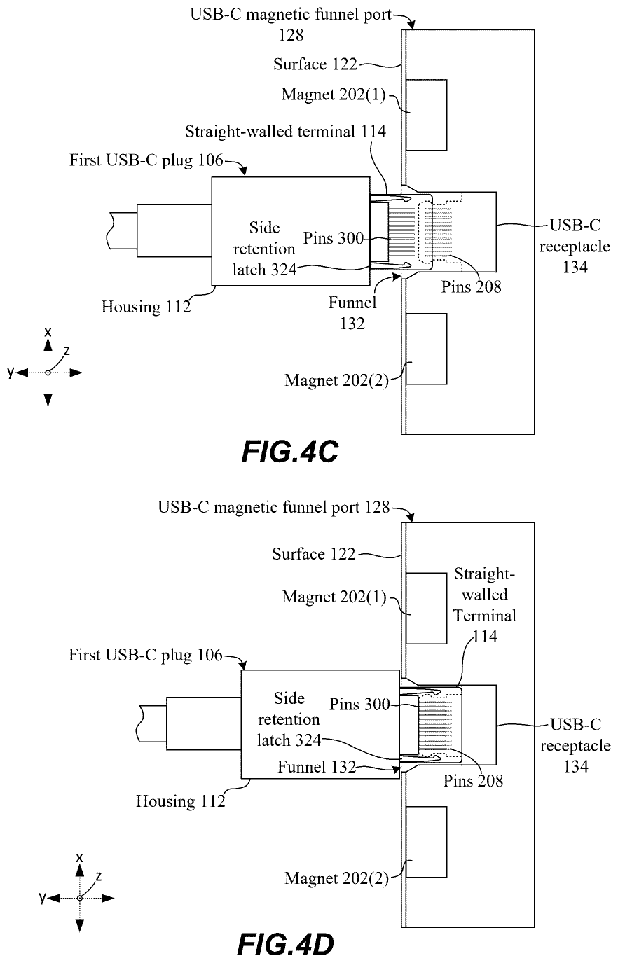

FIGS. 4A-4D collectively show interaction of first USB-C plug 106 with USB-C magnetic funnel port 128. FIG. 4A shows the first USB-C plug spaced away from the USB-C magnetic funnel port 128. FIG. 4B shows the straight-walled terminal 114 of the first USB-C plug approaching the funnel 132 of the USB-C magnetic funnel port 128. FIG. 4C shows the straight-walled terminal 114 of the first USB-C plug at the distal end of the funnel 132 and beginning to engage the USB-C receptacle 134 of the USB-C magnetic funnel port 128. FIG. 4D shows the straight-walled terminal 114 of the first USB-C plug fully engaged with the USB-C receptacle of the USB-C magnetic funnel port 128. This mechanical engagement positions pins 300 of first USB-C plug 106 against pins 208 of USB-C receptacle 134 sufficient for electrical connection.

In this implementation, first USB-C plug 106 includes straight-walled terminal 114 that has a width W1 and a length L1. USB-C magnetic funnel port 128 has a relatively larger width W2 as defined by the funnel 132 at the first surface 122 (e.g., across relatively larger obround shape at the first surface as indicated at 204 of FIG. 2A) and a relatively smaller width W3 at the junction of the funnel 132 and the USB-C receptacle 134 (e.g., across relatively smaller obround shape at the USB-C receptacle 134 as indicated at 206). The width W1 of the straight-walled terminal 114 is slightly less than width W3 to allow insertion of the straight-walled terminal 114 into the USB-C receptacle 134.

Note that while the term ‘straight-walled terminal’ is a useful characterization, some implementations are completely straight-walled (e.g., having a consistent width) while other implementations include a slight taper, such as less than 10% along the length of the straight-walled terminal 114 to facilitate insertion into the USB-C receptacle. Regardless of whether the straight-walled terminal 114 is completely straight or has a slight taper, insertion of the straight-walled terminal into the USB-C receptacle 134 entails precise angular orientation of the straight-walled terminal. For instance, for successful insertion, the orientation has to be generally perpendicular to the first surface 122 (e.g., parallel to the y reference axis). Traditionally, the user had to provide this angular alignment. In the present implementations, the funnel 132 in front of the USB-C receptacle 134 facilitates this angular alignment for the user as the straight-walled terminal 114 moves in the y reference direction through the funnel 132 towards the USB-C receptacle 134.

Further, with a traditional USB-C port, the user would need to align the straight-walled terminal in the x and z reference directions so that the straight-walled terminal was precisely aligned to enter the USB-C receptacle. In the present implementations, as shown in FIG. 4C, the funnel 132 automatically provides this alignment so that the straight-walled terminal 114 is automatically guided into alignment with the USB-C receptacle 134 as the straight-walled terminal 114 travels in the y reference direction through the funnel 132 towards the USB-C receptacle 134.

FIG. 4D shows the straight-walled terminal 114 fully mechanically engaging the USB-C receptacle 134. Specifically, the side retention latches 324 are resilient and are creating a mechanical clamping force toward one another on the USB-C receptacle. In this configuration, the mechanical engagement also causes electrical contact between the pins 300 of the first USB-C plug 106 and the pins 208 of the USB-C receptacle 134. Removal of the first USB-C plug entails moving the first USB-C plug straight back in the y reference direction opposite to the insertion process to overcome the physical clamping force on the USB-C receptacle 134. Other movement, such as in the xz directions can damage the first USB-C plug 106 and/or the USB-C receptacle 134 due to the mechanical engagement.

As explained above, the USB-C magnetic funnel port 128 can be used with a standard USB-C plug when the user desires. In such cases, the USB-C magnetic funnel port 128 offers better performance, such as ease of alignment and insertion of the standard USB-C plug, than traditional USB-C ports. The description below explains some of the advantages of the USB-C magnetic funnel port 128 when used with tapered magnetic USB-C plugs 108.

FIGS. 5A-5I collectively show interaction of tapered magnetic USB-C plug 108 with USB-C magnetic funnel port 128. As illustrated in this sequence of FIGS., magnetic attraction between the tapered magnetic USB-C plug 108 and the USB-C magnetic funnel port 128 automatically aligns the tapered terminal 118 with and into the funnel 132. Stated another way, this configuration provides a technical solution where the magnetic attraction automatically corrects any misalignment between the tapered magnetic USB-C plug 108 and USB-C magnetic funnel port 128, whether angular in the y reference direction and/or displacement in the xz reference plane and guides the tapered terminal 118 into the USB-C receptacle to complete electrical connections between the tapered magnetic USB-C plug 108 and the USB-C magnetic funnel port 128.

FIG. 5A shows the tapered magnetic USB-C plug 108 spaced away from the USB-C magnetic funnel port 128. FIG. 5A shows the proximal and distal funnel widths W2 and W3, respectively. FIG. 5A also introduces proximal and distal widths W4 and W5, respectively of tapered terminal 118. The tapered terminal 118 is wider (W4) at (e.g., proximate to) the housing 116 than distal from the housing 116 (W5). The distal width W3 of the funnel is greater than the distal width W5 of the tapered terminal, but narrower than the proximal width W4. Thus, the relative widths of the tapered terminal 118 and the funnel 132 serve to control the extent of movement of the tapered terminal 118 into the funnel 132 in the y reference direction.

Note that the tapered terminal 118 has a length L2 that is shorter than length L1 of the straight-walled terminal 114 of FIG. 4A. For instance, the tapered terminal can be one to two millimeters shorter than the straight-walled terminal. Note also that the tapered terminal 118 includes rounded corners 502 at the distal end. The rounded corners 502 facilitate entry of the tapered terminal 118 into the funnel 132 as is illustrated in the sequence represented by FIGS. 5B-5I.

FIG. 5B shows the tapered magnetic USB-C plug 108 approaching the USB-C magnetic funnel port 128. At this point, magnetic forces between magnet 312(2) on the tapered magnetic USB-C plug 108 and magnet 202(1) on the USB-C magnetic funnel port 128 are pulling tapered magnetic USB-C plug 108 and USB-C magnetic funnel port 128 together.

FIG. 5C shows one end of the housing 116 of the tapered magnetic USB-C plug 108 touching surface 122 of the USB-C magnetic funnel port 128 (e.g., this touching surface or point of contact functions as a pivot point (PP) on FIG. 5C) as the magnetic attraction between magnets 312(2) and 202(1) continues. This magnetic attraction has aligned the tapered magnetic USB-C plug 108 and the USB-C magnetic funnel port 128 in the x and z reference directions while moving them towards each other in the y reference direction. Magnetic attraction between magnets 312(2) and 202(1) as well as 312(1) and 202(2) is creating a counterclockwise rotational force on the tapered magnetic USB-C plug 108 towards the USB-C magnetic funnel port 128 on the device so that the tapered magnetic USB-C plug 108 is rotating around the point of contact (e.g., pivot point) between housing 116 and surface 122.

Note that the pivot point PP can be relatively distant from the funnel 132. For instance, the pivot point can be at a distance from the funnel in a range from 0.5 to 1.5 times the width W4 of the proximal end of the tapered terminal 118. In the illustrated configuration, the pivot point is at a distance of about 0.75 of width W4 from the funnel 132. This configuration allows either end of the tapered magnetic USB-C plug 108 to be positioned against the surface 122 of the device and for the rest of the tapered magnetic USB-C plug 108 including the tapered terminal 118 to be rotated into position by the magnetic forces.

As mentioned above relative to FIG. 5C, magnets 312(2) and 202(1) have aligned the tapered magnetic USB-C plug 108 relative to the USB-C magnetic funnel port 128 until the tapered terminal 118 is aligned with funnel 132. Note, that as the rotation continues, the shape of the funnel 132 of the USB-C magnetic funnel port 128 and/or the tapered shape of the tapered terminal 118 allow the tapered terminal to rotate into the funnel without binding or otherwise blocking the rotation.

FIG. 5D shows continued counterclockwise rotation of the tapered magnetic USB-C plug 108 with the tapered terminal 118 passing through the funnel 132 and reaching the USB-C magnetic funnel port 128 without binding. At this point, the long axis of the housing 116 of the tapered magnetic USB-C plug 108 is defining an angle of about 10 degrees relative to the surface 122. The combination of the tapered terminal 118, the funnel 132, magnets 312, and/or magnets 202 will automatically guide the tapered terminal into the USB-C magnetic funnel port 128. Though 10 degrees of angular misalignment is illustrated here, some implementations readily automatically guide the tapered terminal into the USB-C magnetic funnel port 128 at 20 degrees or more of angular misalignment. Note further that in the two-dimensional representation of FIGS. 5A-5I, the angular misalignment is shown in the x reference direction. However, the present concepts accommodate misalignment in either the x and/or z reference directions and automatically correct the misalignment due to the magnetic attraction between the tapered magnetic USB-C plug 108 and the USB-C magnetic funnel port 128.

FIGS. 5E and 5F show continued rotation to about eight degrees and six degrees, respectively due to magnetic forces between magnets 312(2) and 202(1) and magnets 312(1) and 202(2). The tapered shape of the tapered terminal 118 in combination with the funnel 132 allows the tapered terminal to continue to rotate into the USB-C receptacle 134 without binding. This rotation continues through the four-degree orientation of FIG. 5G and the two-degree orientation of FIG. 5H to the zero-degree orientation of FIG. 5I.

At the zero-degree orientation of FIG. 5I, the long axis of the housing 116 is biased against and is approximately parallel to surface 122, such as within one degree plus or minus. The attraction between magnets 312(2) and 202(1) and magnets 312(1) and 202(2) forces the tapered terminal 118 against the USB-C receptacle 134, such that pins 316 of the tapered terminal 118 are in electrical contact with pins 208 of USB-C receptacle 134. This electrical contact does not rely on mechanical engagement between the tapered terminal 118 and the USB-C receptacle 134 to maintain the tapered terminal in the USB-C receptacle. Instead, a majority of the retention forces are provided by the magnetic attraction.

Based on the magnetic retention, if an external force is applied to the tapered magnetic USB-C plug 108, such as via insulated conductors 110, that is greater than the magnetic attraction, the tapered terminal 118 can be withdrawn from the USB-C receptacle 134 without any damage to the tapered magnetic USB-C plug 108 or the USB-C magnetic funnel port 128. Thus, this solution achieves all of the attributes of magnetic attachment/detachment without sacrificing the full functionality of a standard USB-C port.

Note that the implementations described above provide many of the current novel aspects. However, other configurations are contemplated. For instance, an alternative to the tapered terminal 118 is a terminal having a uniform width equivalent to width W5 shown on FIG. 5A. This uniform terminal can have a length that is one to two millimeters shorter than a standard USB-C plug so that it is long enough for its pins to make contact with the pins of the USB-C receptacle but short enough to limit mechanical engagement. The two sets of magnets 312(2) and 202(1) as well as 312(1) and 202(2) will align the terminal as they force the terminal into the funnel 132 until its pins 316 make electrical contact with pins 208 of the USB-C receptacle 134. The magnetic attraction will hold the terminal in place unless acted on by an external force, such as a disconnect force of the user purposefully pulling on the USB-C cable 104 or accidentally tripping over the USB-C cable.

The components described herein can be formed from materials used in device and connector technologies. For example, the conductors can include various conductive materials, such as various metals including homogeneous materials, such as copper, blends, and/or coated metals. The housings can be formed from various polymers and/or composites using existing methods, such as molding, machining, and/or additive (3D printing techniques). Various magnetic materials can be employed, such as traditional ferromagnetic materials.

Although the subject matter has been described in language specific to structural features and/or methodological acts relating to magnetic USB-C concepts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

### Additional Examples

Various examples are described above. Additional examples are described below. One example includes a device comprising a housing including multiple surfaces that collectively define a volume and a USB-C magnetic funnel port comprising a USB-C receptacle positioned within the volume and recessed behind an individual surface, the recessed USB-C receptacle comprising a USB-C compliant arrangement of pins and a funnel interposed between a pair of magnets and extending from the individual surface to the recessed USB-C receptacle.

Another example can include any of the above and/or below examples where the funnel extends in a range of 1 millimeter to 2 millimeters from the individual surface to the USB-C receptacle as measured orthogonally to the individual surface.

Another example can include any of the above and/or below examples where the USB-C compliant arrangement of pins comprises a first set of twelve pins spaced apart from a second set of twelve pins, and wherein the first set of twelve pins is generally parallel to the second set of twelve pins as viewed orthogonally to the first surface and through the funnel.

Another example can include any of the above and/or below examples where the funnel is a relatively larger obround shape at the individual surface and a relatively smaller obround shape at the USB-C receptacle.

Another example can include any of the above and/or below examples where the pair of magnets are positioned adjacent to each end of the relatively larger obround shape underneath the individual surface.

Another example can include any of the above and/or below examples where the pair of magnets contact the funnel or wherein the pair of magnets are spaced apart from the funnel.

Another example can include any of the above and/or below examples where the device comprises a notebook computer, a tablet, a smartphone, or a power supply unit.

Another example includes a USB-C cable comprising insulated conductors extending between a first USB-C plug and a second tapered magnetic USB-C plug, the first USB-C plug comprising an obround cylindrical shaped terminal around a USB-C compliant arrangement of pins that are connected to the insulated conductors, and the second tapered magnetic USB-C plug comprising a terminal positioned between magnets and including a proximal relatively larger obround cylindrical shaped portion and the terminal comprising a distal relatively smaller obround cylindrical shaped portion that are connected by a tapered intermediate portion, the distal relatively smaller obround cylindrical shaped portion including another USB-C compliant arrangement of pins that are connected to the insulated conductors.

Another example can include any of the above and/or below examples where the first USB-C plug further comprises a housing that extends along a long axis, and wherein the first USB-C plug receives the insulated conductors coextensive with the long axis and the terminal extends generally coextensive with the long axis.

Another example can include any of the above and/or below examples where the second tapered magnetic USB-C plug further comprises a housing that extends along a long axis, and wherein the second tapered magnetic USB-C plug receives the insulated conductors coextensive with the long axis and the terminal extends generally orthogonally to the long axis.

Another example can include any of the above and/or below examples where the USB-C cable further comprises magnets positioned in the housing on each side of the obround cylindrical shaped terminal of the second tapered magnetic USB-C plug.

Another example can include any of the above and/or below examples where the terminal of the second tapered magnetic USB-C plug comprises rounded corners at the relatively smaller obround cylindrical shaped portion.

Another example includes a system comprising a USB-C cable comprising insulated conductors extending between a first USB-C plug and a second tapered magnetic USB-C plug, the first USB-C plug comprising a relatively straight-walled terminal having a consistent width and positioned around a first USB-C compliant arrangement of pins that are connected to the insulated conductors, and the second tapered magnetic USB-C plug comprising a tapered terminal including a proximal end having a width that is greater than the width of the first USB-C plug and tapering to a distal end having approximately the same width as the first USB-C plug and positioned around another USB-C compliant arrangement of pins that are connected to the insulated conductors.

Another example can include any of the above and/or below examples where the system further comprises a device comprising a housing defining a volume, a funnel extending from a surface of the housing into the volume and terminating at a USB-C receptacle comprising a USB-C compliant arrangement of pins.

Another example can include any of the above and/or below examples where a width of the USB-C receptacle is greater than the width of the terminal of the first USB-C plug and the width of the distal end of the terminal of the second tapered magnetic USB-C plug, but narrower than the width of the proximal end of the terminal of the second tapered magnetic USB-C plug.

Another example can include any of the above and/or below examples where the second tapered magnetic USB-C plug further comprises a housing that extends along a long axis, and wherein the second tapered magnetic USB-C plug receives the insulated conductors coextensive with the long axis and the terminal extends generally orthogonally to the long axis.

Another example can include any of the above and/or below examples where the housing of the second tapered magnetic USB-C plug further includes magnets on each side of the terminal of the second tapered magnetic USB-C plug and wherein the device further includes magnets under the first surface on each side of the funnel.

Another example can include any of the above and/or below examples where the magnets on each side of the terminal of the second tapered magnetic USB-C plug and the magnets under the first surface of the device collectively bias the USB-C compliant arrangement of pins of the second tapered magnetic USB-C plug against the USB-C compliant arrangement of pins of the USB-C receptacle without mechanical retention between the second tapered magnetic USB-C plug and the device.

Another example can include any of the above and/or below examples where the tapered terminal of the second tapered magnetic USB-C plug and the funnel of the device allow the magnets on each side of the terminal of the second tapered magnetic USB-C plug and the magnets under the first surface of the device to bias the second tapered magnetic USB-C plug into the USB-C receptacle when the terminal of the second tapered magnetic USB-C plug enters the funnel at an angle of up to 20 degrees of misalignment.

Another example can include any of the above and/or below examples where the tapered terminal of the second tapered magnetic USB-C plug and the funnel of the device allow the magnets on each side of the terminal of the second tapered magnetic USB-C plug and the magnets under the first surface of the device to bias the second tapered magnetic USB-C plug into the USB-C receptacle when the terminal of the second plug enters the funnel at an angle of up to 10 degrees of misalignment.

Another example can include any of the above and/or below examples where the bias is configured to correct the misalignment so that the another USB-C compliant arrangement of pins make electrical contact with the corresponding terminal of the second tapered magnetic USB-C plug as the terminal of the second tapered magnetic USB-C plug approaches the USB-C receptacle so that the another USB-C compliant arrangement of pins is positioned against and makes electrical contact with corresponding pins of the USB-C compliant arrangement of pins of the USB-C receptacle.

Another example can include any of the above and/or below examples where the distal end of the second tapered magnetic USB-C plug comprises rounded corners.

Another example can include any of the above and/or below examples where the tapered terminal of the second tapered magnetic USB-C plug is shorter than the straight-walled terminal of the first USB-C plug.

Another example includes a system comprising a USB-C cable comprising insulated conductors extending between a first USB-C plug and a second magnetic USB-C plug, the first USB-C plug comprising a first housing and a first terminal positioned around a first USB-C compliant arrangement of pins that are connected to the insulated conductors, and the second magnetic USB-C plug comprising a second housing including magnets and a second terminal extending from the housing a shorter length than the first terminal and positioned around another USB-C compliant arrangement of pins that are connected to the insulated conductors.

Another example can include any of the above and/or below examples where the second magnetic USB-C plug is tapered or wherein the second magnetic USB-C plug is straight-walled.

1. A device, comprising:
a housing including multiple surfaces that collectively define a volume; and,
a USB-C magnetic funnel port comprising a USB-C receptacle positioned within the volume and recessed behind an individual surface, the recessed USB-C receptacle comprising a USB-C compliant arrangement of pins and a funnel interposed between a pair of magnets and extending from the individual surface to the recessed USB-C receptacle.

2. The device of claim 1, wherein the funnel extends in a range of 1 millimeter to 2 millimeters from the individual surface to the USB-C receptacle as measured orthogonally to the individual surface.

3. The device of claim 1, wherein the USB-C compliant arrangement of pins comprises a first set of twelve pins spaced apart from a second set of twelve pins, and wherein the first set of twelve pins is generally parallel to the second set of twelve pins as viewed orthogonally to the first surface and through the funnel.

4. The device of claim 1, wherein the funnel is a relatively larger obround shape at the individual surface and a relatively smaller obround shape at the USB-C receptacle.

5. The device of claim 4, wherein the pair of magnets are positioned adjacent to each end of the relatively larger obround shape underneath the individual surface.

6. The device of claim 5, wherein the pair of magnets contact the funnel or wherein the pair of magnets are spaced apart from the funnel.

7. The device of claim 6, wherein the device comprises a notebook computer, a tablet, a smartphone, or a power supply unit.

8. A USB-C cable, comprising:
insulated conductors extending between a first USB-C plug and a second tapered magnetic USB-C plug;
the first USB-C plug comprising an obround cylindrical shaped terminal around a USB-C compliant arrangement of pins that are connected to the insulated conductors; and,
the second tapered magnetic USB-C plug comprising a terminal positioned between magnets and including a proximal relatively larger obround cylindrical shaped portion and the terminal comprising a distal relatively smaller obround cylindrical shaped portion that are connected by a tapered intermediate portion, the distal relatively smaller obround cylindrical shaped portion including another USB-C compliant arrangement of pins that are connected to the insulated conductors.

9. The USB-C cable of claim 8, wherein the first USB-C plug further comprises a housing that extends along a long axis, and wherein the first USB-C plug receives the insulated conductors coextensive with the long axis and the terminal extends generally coextensive with the long axis.

10. The USB-C cable of claim 8, wherein the second tapered magnetic USB-C plug further comprises a housing that extends along a long axis, and wherein the second tapered magnetic USB-C plug receives the insulated conductors coextensive with the long axis and the terminal extends generally orthogonally to the long axis.

11. The USB-C cable of claim 10, further comprising magnets positioned in the housing on each side of the obround cylindrical shaped terminal of the second tapered magnetic USB-C plug.

12. The USB-C cable of claim 8, wherein the terminal of the second tapered magnetic USB-C plug comprises rounded corners at the relatively smaller obround cylindrical shaped portion.

13. A system, comprising:
a USB-C cable comprising insulated conductors extending between a first USB-C plug and a second tapered magnetic USB-C plug;
the first USB-C plug comprising a relatively straight-walled terminal having a consistent width and positioned around a first USB-C compliant arrangement of pins that are connected to the insulated conductors; and,
the second tapered magnetic USB-C plug comprising a tapered terminal including a proximal end having a width that is greater than the width of the first USB-C plug and tapering to a distal end having approximately the same width as the first USB-C plug and positioned around another USB-C compliant arrangement of pins that are connected to the insulated conductors.

14. The system of claim 13, further comprising a device comprising a housing defining a volume, a funnel extending from a surface of the housing into the volume and terminating at a USB-C receptacle comprising a USB-C compliant arrangement of pins.

15. The system of claim 14, wherein a width of the USB-C receptacle is greater than the width of the terminal of the first USB-C plug and the width of the distal end of the terminal of the second tapered magnetic USB-C plug, but narrower than the width of the proximal end of the terminal of the second tapered magnetic USB-C plug.

16. The system of claim 15, wherein the second tapered magnetic USB-C plug further comprises a housing that extends along a long axis, and wherein the second tapered magnetic USB-C plug receives the insulated conductors coextensive with the long axis and the terminal extends generally orthogonally to the long axis.

17. The system of claim 16, wherein the housing of the second tapered magnetic USB-C plug further includes magnets on each side of the terminal of the second tapered magnetic USB-C plug and wherein the device further includes magnets under the first surface on each side of the funnel.

18. The system of claim 17, wherein the magnets on each side of the terminal of the second tapered magnetic USB-C plug and the magnets under the first surface of the device collectively bias the USB-C compliant arrangement of pins of the second tapered magnetic USB-C plug against the USB-C compliant arrangement of pins of the USB-C receptacle without mechanical retention between the second tapered magnetic USB-C plug and the device.

19. The system of claim 18, wherein the tapered terminal of the second tapered magnetic USB-C plug and the funnel of the device allow the magnets on each side of the terminal of the second tapered magnetic USB-C plug and the magnets under the first surface of the device to bias the second tapered magnetic USB-C plug into the USB-C receptacle when the terminal of the second tapered magnetic USB-C plug enters the funnel at an angle of up to 20 degrees of misalignment.

20. The system of claim 19, wherein the bias is configured to correct the misalignment so that the another USB-C compliant arrangement of pins make electrical contact with the corresponding pins of the second tapered magnetic USB-C plug as the terminal of the second tapered magnetic USB-C plug approaches the USB-C receptacle so that the another USB-C compliant arrangement of pins is positioned against and makes electrical contact with the corresponding pins of the USB-C compliant arrangement of pins of the USB-C receptacle.
